(19) United States
(12) Patent Application Publication
(10) Pub. No.: US 2005/0277533 A1
(43) Pub. Date: Dec. 15, 2005

(54) A METHOD AND MACHINE FOR ATTOMATICALLY AND CONTINUOUSLY APPLING A POURING SPOUT ON PRE-SHEARED PAPERBOARD OVAL ANSD SQUARE DISCS FOR CLOSING PAPERBOARD BOXES

(76) Inventor: Franco Pagliari, Brescia (IT)

Correspondence Address: HEDMAN & COSTIGAN P.C., 1185 AVENUE OF THE AMERICAS, NEW YORK, NY, 10036, US

(21) Appl. No.: 10/858,000

(22) Filed: Jun. 1, 2004

(51) Int. Cl. B31B 1/84

(52) U.S. Cl. 493/87

(57) ABSTRACT

A machine for automatically and continuously applying a pouring spout on pre-sheared paperboard oval and square discs for closing paperboard boxes, characterized in that said machine comprises a driving assembly for conveying successively said pre-sheared paperboard oval and square discs to a series of processing stations, including at least a feeding station, a glueing station, a spout application station and one or more label application stations.

### BACKGROUND OF THE INVENTION

The present invention relates to a machine for automatically and continuously applying a pouring spout on pre-sheared paperboard oval and square discs for closing paperboard boxes.

Prior art machines of the above mentioned type are affected by the drawback that they must be frequently stopped for replacing the pre-sheared strip which is supplied to the mechanism for forming the pouring spouts.

### SUMMARY OF THE INVENTION

Accordingly, the aim of the present invention is to provide such a machine specifically designed for handling a pre-sheared paperboard oval or square disc, to drive, by an intermittent and/or continuous movement, said disc to several processing operations to associate with said disc the pouring spout, wherein said pouring spout is covered by a self-glueing label, having anti-tampering properties, in an automatic and continuous manner, i.e. without interrupting the making process.

Within the scope of the above mentioned aim, a main object of the present invention is to provide such a machine which is further adapted to automatically control a proper glueing of the pouring spout.

According to one aspect of the present invention, the above mentioned aim and objects, as well as yet other objects, which will become more apparent hereinafter, are achieved by a machine for automatically and continuously applying a pouring spout on pre-sheared paperboard oval and square discs for closing paperboard boxes, characterized in that said machine comprises a driving assembly for conveying successively said pre-sheared paperboard oval and square discs to a series of processing stations, including at least a feeding station, a glueing station, a spout application station and one or more label application stations.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is an elevation view of the machine for automatically and continuously applying a pouring spout on pre-sheared paperboard oval and square discs for closing paperboard boxes according to the invention, as longitudinally seen;

FIG. 2 is a partial top plan view of the machine shown in the preceding figure;

FIGS. 3 and 4 show operating steps for applying a pouring spout respectively to a paperboard square disc and a paperboard oval disc; and

FIG. 5 shows a modified embodiment of the machine shown in the preceding figures, including, instead of a conveyor belt driven in a linear direction, a rotary carousel adapted to turn about a vertical axis.

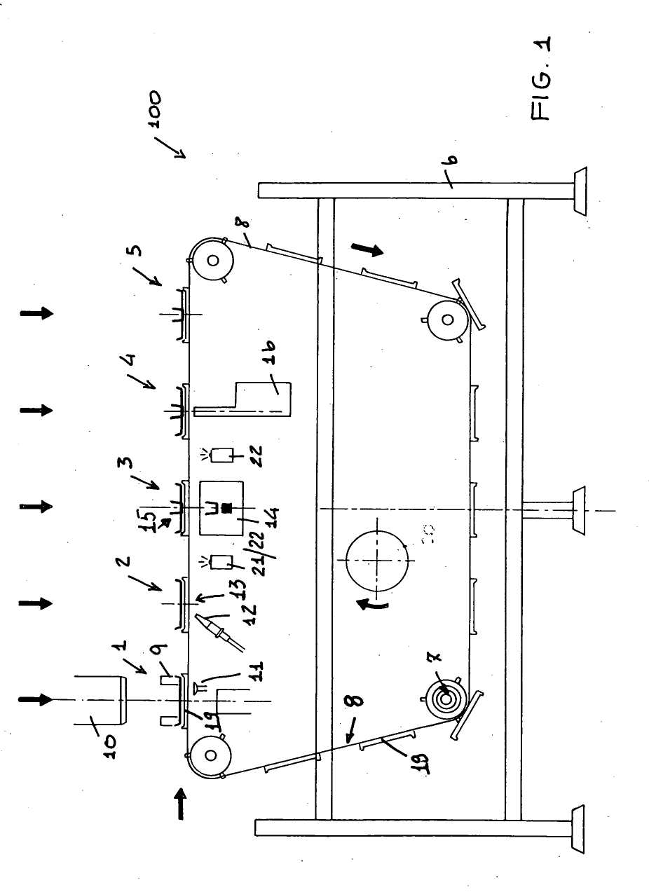

### DESCRIPTION OF THE PREFERRED EMBODIMENTS

With reference to the number references of the above mentioned drawing figures, the machine for automatically and continuously applying a pouring spout 15 on pre-sheared paperboard oval and square discs to be applied for closing paperboard boxes, according to the present invention, which has been generally indicated by the reference number 100, comprises a bearing framework 6, supporting a driving assembly 7, which conveys to successive processing stations a plurality of pre-sheared paperboard oval or square discs 19, by means of a conveyor belt 8.

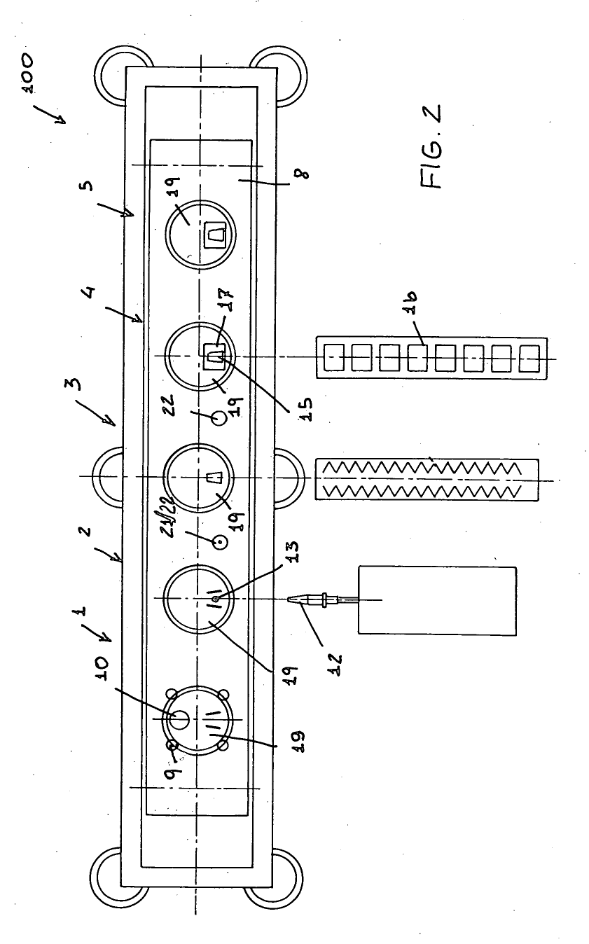

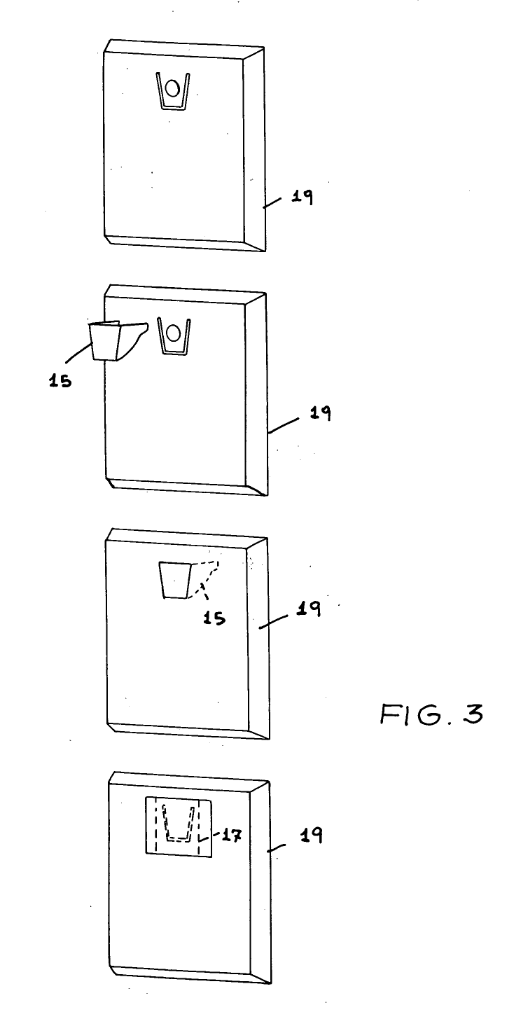

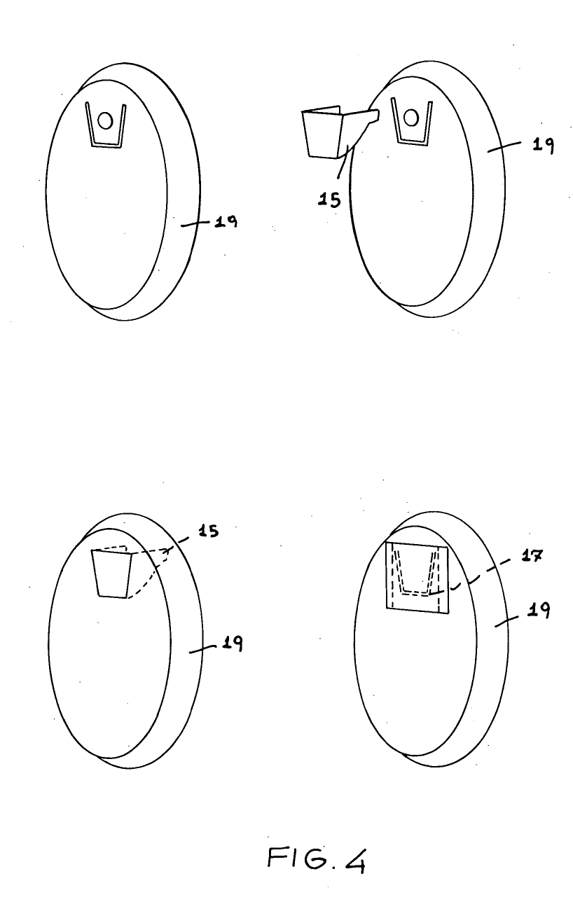

FIG. 2 shows the processing stations included in the machine according to the invention.

More specifically, at the processing station 1, the pusher element 10 downward urges the pre-sheared paperboard oval or square disc 19, to engage said disc in holding nose elements 9.

Then, the paperboard disc is locked by a suction element for cup 11.

At the processing station 2, a nozzle 12 applies a glue drop at the point 13, to allow, at a following station, to connect the delivery spout 15.

During the translation movement from the processing station 2 to the processing station 3, it is possible to control the glue drop being applied by a glue drop sensor 21 designed for sensing or detecting the glue temperature, in the case of hot-melt adhesive materials, or a reader device 22 adapted to detect the luminescence of the vinyl adhesive material being applied.

The processing station 3 comprises a mechanism for forming and applying the delivery spout 15, which mechanism forms and applies on the pre-sheared paperboard oval or square disc 19, at the point 13, a delivery spout 15.

During the translation from the processing station 3 to the processing station 4, it is possible to control the proper application of the pouring spout 15 by a further sensor 22 designed for detecting the luminescence difference between the paperboard disc receiving the pouring spout 15 and the neutral luminescence of said pouring spout.

The processing station 4 comprises an apparatus 16 for applying self-glueing labels, which applies a label 17 on the pouring spout 15, as applied on the pre-sheared paperboard oval or square disc 19.

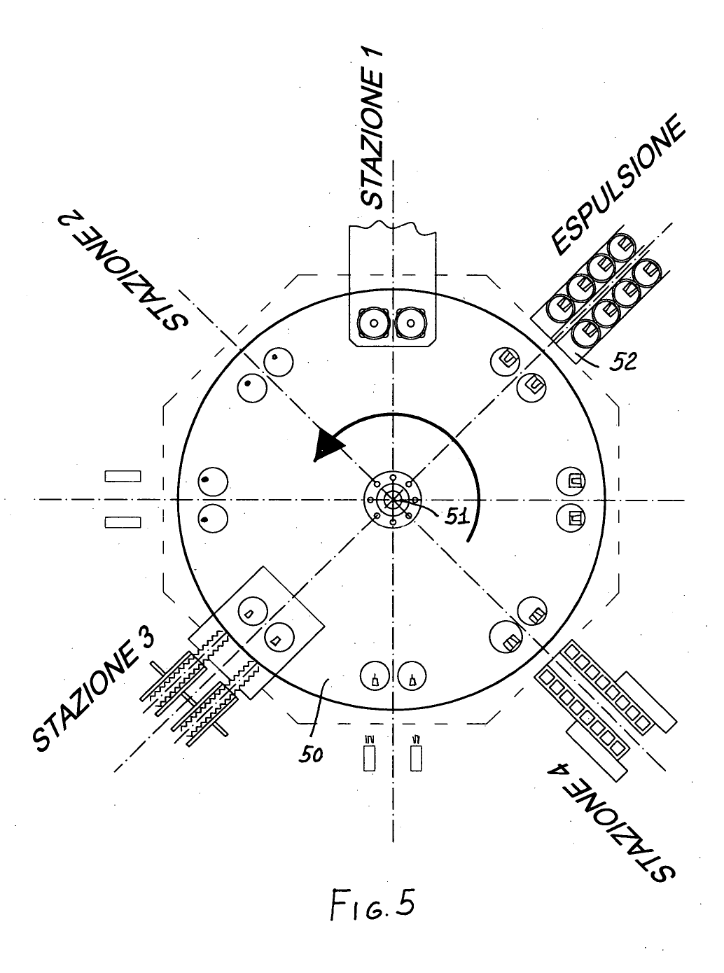

FIG. 5 shows a modified embodiment of the machine according to the invention, including a rotary carousel 50 replacing the above mentioned conveyor belt 8.

This rotary carousel 50, by turning about a vertically extending supporting shaft 51, provides a translation movement, to translate the discs being processed, to the above mentioned processing stations 1, 2, 3 and 4, by performing the same processing steps which have been above disclosed with respect to the machine embodiment including the conveyor belt 8.

At the operating position 52, shown in FIG. 5, the boxes or packages are ejected from the machine after having applied the delivery spout 15 by the operating steps which have been above disclosed.

It has been found that the invention fully achieves the intended aim and objects.

In fact, the invention provides a machine for automatically and continuously applying a pouring spout on pre-sheared paperboard oval and square discs for closing paperboard boxes, which can continuously operate, without any interruptions, and with a continuous sequence of the making operating cycles.

The main feature of the invention is that the holding nose elements 9 are specifically designed for holding the starting position during the translation movements of the pre-sheared paperboard oval or square discs.

Thus, the adhesive material, pouring spout and self-glueing label can be properly arranged to meet the contingent requirements.

Another main feature of the machine for automatically and continuously applying a pouring spout on pre-sheared paperboard oval and squared discs for closing paperboard boxes according to the present invention, is that this machine allows to properly control a proper application of the glue drop for glueing the pouring spout to the receiving paperboard box.

This control is performed by an electronic sensor detecting the temperature of the glue being applied, if the glue is a hot-melt adhesive, or by an optical reading or sensing device, specifically designed for detecting the luminescence of the vinyl adhesive being applied.

After having applied the pouring spout on the receiving oval or square disc, the inventive machine is also adapted to control the proper application of the pouring spout, by using an optical reading device detecting the difference between the luminescence of the paperboard box receiving the pouring spout and the neutral luminescence of the pouring spout itself.

In practicing the invention, the used materials, as well as the contingent size and shapes, can be any depending on requirements and the status of the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method for automatically and continuously applying a pouring spout on pre-shaped paperboard oval and square discs for closing paperboard boxes, comprising the steps of feeding, by disc feeding means, said oval and square discs to a first processing station, downward pressing each said disc to engage said disc in holding nose elements said disc by suction, applying, in a second processing station, a glue drop to each said locked disc, controlling, by glue drop sensing means, if said glue drop has been properly applied, applying, in a third processing station, a delivery spout to said glue drop, controlling, by delivery spout sensing means, if said delivery spout has been properly applied to the glue drop and applying, in a fourth processing station, a self glueing label to the pouring spout.

13. A method according to claim 12, wherein said glue drop sensing means comprise a glue drop temperature sensing means.

14. A method according to claim 12, wherein said glue drop sensing means comprise a glue drop luminescence sensing means.

15. A method according to claim 12, wherein said delivery spout sensing means comprise luminescence sensing means.

16. A machine for carrying out a method according to claim 12, said machine comprising a driving assembly for conveying successively said pre-sheared paperboard oval and square discs to a series of processing stations, including at least a disc feeding station, a glueing station, a delivery spout application station and at least a label application station, said machine further comprising a bearing framework for supporting said driving assembly conveying, by a conveyor belt, said pre-sheared paperboard oval and square discs, to said processing station series, wherein said feeding station comprises a pusher element downward urging said pre-sheared paperboard oval and square disc so as to engage said disc in holding nose elements, where each said pre-sheared paperboard oval and square disc is locked by a suction cup, wherein said glueing station comprises a glue nozzle applying a glue drop to attach said delivery spout to each said disc, and wherein said machine further comprises control means for controlling an application of a glue drop, said control means including a temperature sensor sensing a temperature of said glue drop, for hot-melt adhesive materials, or a read-out sensor for detecting a luminescence of a vinyl adhesive material being applied.

17. A machine, according to claim 16, wherein said machine further comprises a further sensor for sensing a luminescence difference between a paperboard box receiving said spout and a neutral luminescence of said pouring spout.

18. A machine, according to claim 16, wherein said machine further comprises a rotary carousel, said rotary carousel being adapted to turn about a vertical supporting shaft.
